(19) United States
(12) Patent Application Publication
(10) Pub. No.: US 2025/0253949 A1
(43) Pub. Date: Aug. 7, 2025

(54) FREE SPACE OPTICAL COMMUNICATION WITH AIRCRAFT

(71) Applicant: Airbus Operations Limited, FILTON (GB)

(72) Inventors: Crisanto QUINTANA SANCHEZ, FILTON (GB); Gavin ERRY, FILTON (GB); Yoann THUEUX, FILTON (GB)

(21) Appl. No.: 19/043,809

(22) Filed: Feb. 3, 2025

(30) Foreign Application Priority Data
Feb. 5, 2024 (GB) 2401455.7

(51) Int. Cl. H04B 10/112; G07C 5/08

(52) U.S. Cl. CPC H04B 10/1129; G07C 5/0858

(57) ABSTRACT

A method comprising moving a vehicle between a plurality of parked aircraft; at each aircraft, receiving aircraft-to-ground data from the aircraft at the vehicle by free-space-optical communication and storing the aircraft-to-ground data at the vehicle; and transferring the stored aircraft-to-ground data from the vehicle, wherein stored aircraft-to-ground data from two or more of the aircraft accumulates at the vehicle before it is transferred from the vehicle. Also a vehicle used in such a method.

### CROSS-REFERENCES TO RELATED APPLICATIONS

This application claims the benefit of Great Britain Patent Application Number 2401455.7 filed on Feb. 5, 2024, the entire disclosure of which is incorporated herein by way of reference.

### FIELD OF THE INVENTION

The present invention relates to a method and vehicle for communicating with a parked aircraft by free-space-optical communication.

Note that the term “free-space-optical communication” is used herein to refer to a communication using light which is in the infrared, visible or ultra-violet part of the electromagnetic spectrum.

### BACKGROUND OF THE INVENTION

U.S. Ser. No. 11/777,604 discloses a system and method for updating and maintaining an onboard entertainment server on an aircraft including a gate LiFi access point positioned in a gate area of an airport, the gate LiFi access point having a removable server. An aircraft LiFi receiver is positioned in the aircraft, the aircraft LiFi receiver and the removable server capable of line-of-sight transmission of updated data and a content loader receives the updated data in the onboard entertainment server.

U.S. Pat. No. 8,095,014 discloses a free space optical communications link between an aircraft and an airport ground terminal unit, the link being asymmetric in the sense that a downlink to the aircraft has a much higher bandwidth than the reverse link from the aircraft so that the system is adapted for quickly loading large amounts of data (e.g., in-flight entertainment) onto the aircraft while still providing enough bandwidth for the lesser amounts of data (e.g., maintenance data) required to be transmitted from the aircraft to ground.

### SUMMARY OF THE INVENTION

A first aspect of the invention provides a method comprising: moving a vehicle between a plurality of parked aircraft; at each aircraft, receiving aircraft-to-ground data from the aircraft at the vehicle by free-space-optical communication and storing the aircraft-to-ground data at the vehicle; and transferring the stored aircraft-to-ground data from the vehicle, wherein stored aircraft-to-ground data from two or more of the aircraft accumulates at the vehicle before it is transferred from the vehicle.

Optionally the free-space-optical communication uses infrared light, optionally with a wavelength greater than 1000 nm.

Optionally the free-space-optical communication uses a laser beam.

Optionally the aircraft-to-ground data which accumulates at the vehicle comprises more than 10 terabytes of data or more than 20 terabytes of data or more than 30 terabytes of data.

Optionally the method further comprises moving the vehicle to a base after it has accumulated a full set of aircraft-to-ground data from all of the parked aircraft; and transferring the full set of aircraft-to-ground data from the vehicle at the base.

Optionally the full set of aircraft-to-ground data is transferred from the vehicle at the base by free-space-optical communication.

Optionally at least some of the aircraft-to-ground data is stored in a memory unit and transferred from the vehicle by physically removing the memory unit from the vehicle.

Optionally the stored aircraft-to-ground data is transferred from the vehicle at the same time as the vehicle is moving between the aircraft.

Optionally the method further comprises, at each aircraft, transmitting ground-to-aircraft data from the vehicle to the aircraft by free-space-optical communication and storing the ground-to-aircraft data at the aircraft.

A second aspect of the invention provides a method comprising: moving a vehicle between a plurality of parked aircraft; at each aircraft, transmitting ground-to-aircraft data from the vehicle to the aircraft by free-space-optical communication; and storing the ground-to-aircraft data at the aircraft.

Optionally the free-space-optical communication uses infrared light, optionally with a wavelength greater than 1000 nm.

Optionally the free-space-optical communication uses a laser beam.

Optionally at each aircraft more than 10 terabytes of ground-to-aircraft data or more than 20 terabytes of ground-to-aircraft data are transmitted to the aircraft by the free-space-optical communication.

Optionally the aircraft-to-ground data is received at the vehicle via an incoming steered beam; the ground-to-aircraft data is transmitted from the vehicle via an outgoing steered beam; and the method further comprises, at each aircraft, adjusting an angle of each steered beam so that the steered beams are substantially aligned with each other.

Optionally the aircraft-to-ground data is received at the vehicle via an incoming beam with a divergence less than 10 mrad (for instance less than 10 mrad FWHM) or less than 5 mrad (for instance less than 5 mrad FWHM), and/or the ground-to-aircraft data is transmitted from the vehicle via an outgoing beam with a divergence less than 10 mrad (for instance less than 10 mrad FWHM) or less than 5 mrad (for instance less than 5 mrad FWHM).

Optionally the data is transferred at a rate higher than 0.5 terabits per second.

Optionally the vehicle spends no more than 10 minutes at each parked aircraft.

Optionally the vehicle is a ground-based vehicle or an airborne vehicle.

Optionally each aircraft sends more than 1 terabyte of aircraft-to-ground data to the vehicle.

A third aspect of the invention provides a vehicle for communicating with a parked aircraft by free-space-optical communication, the vehicle comprising: a transmitter configured to generate outgoing light, the outgoing light carrying ground-to-aircraft data; a receiver configured to receive incoming light and sense the incoming light, the incoming light carrying aircraft-to-ground data; and memory for storing the ground-to-aircraft data and the aircraft-to-ground data.

Optionally the transmitter is configured to modulate the outgoing light to encode the ground-to-aircraft data in the outgoing light.

Optionally the memory has a capacity of more than 30 terabytes or more than 50 terabytes.

Optionally the vehicle further comprises a lens configured to collimate the outgoing light to generate a collimated beam.

Optionally the receiver is configured to receive the incoming light via the lens.

Optionally the vehicle further comprises a beam steering device configured to transform the outgoing light to generate a steered beam; and a control system configured to operate the beam steering device to adjust an angle of the steered beam.

Optionally the receiver is configured to receive the incoming light via the beam steering device.

Optionally the vehicle further comprises a lens configured to collimate the outgoing light to generate a collimated beam; a beam steering device configured to transform the collimated beam to generate a steered beam; and a control system configured to operate the beam steering device to adjust an angle of the steered beam, wherein the receiver is configured to receive the incoming light via the beam steering device and the lens.

Optionally the vehicle is a ground-based vehicle or an airborne vehicle.

Optionally the vehicle used in the second aspect is a vehicle according to the third aspect.

Optionally the outgoing light and the incoming light are infrared light.

Optionally the outgoing light and the incoming light are infrared light with a wavelength greater than 1000 nm.

Optionally the outgoing light and the incoming light have different peak wavelengths.

Optionally the outgoing light and the incoming light are generated by lasers.

A fourth aspect of the invention provides an aircraft fuselage comprising: a window; and an aircraft transceiver housed inside the fuselage, wherein the aircraft transceiver is configured to transfer data to and from the aircraft by free-space-optical communication when the aircraft is parked, the aircraft transceiver comprising: a transmitter configured to generate outgoing light and transmit the outgoing light through the window, the outgoing light carrying aircraft-to-ground data; and a receiver configured to receive incoming light through the window and sense the incoming light, the incoming light carrying ground-to-aircraft data.

Optionally the transmitter is configured to modulate the outgoing light to encode the aircraft-to-ground data in the outgoing light.

Optionally the outgoing light and the incoming light are infrared light.

Optionally the outgoing light and the incoming light are infrared light with a wavelength greater than 1000 nm.

Optionally the outgoing light and the incoming light have different peak wavelengths.

Optionally the outgoing light and the incoming light are generated by lasers.

Optionally the window is on a port or starboard side of the fuselage.

Optionally the window is on a port side of the fuselage.

Optionally the aircraft fuselage further comprises a passenger door, wherein the window is aft of the passenger door.

Optionally the aircraft transceiver comprises a laser and/or a lens and/or a beam-steering device.

Optionally the aircraft transceiver is housed in a compartment of the fuselage.

Optionally the aircraft transceiver is housed in a pressurized compartment of the fuselage.

Optionally the aircraft transceiver is housed in a passenger compartment of the fuselage.

Optionally the window comprises a transparent outer pane and a transparent inner pane.

Optionally the aircraft fuselage further comprises a fuselage shell, wherein the window is fit into a cut-out in the fuselage shell.

Optionally the transmitter and receiver are inside an overhead luggage compartment.

Optionally the window is a passenger window, adjacent to a passenger seat.

Optionally the window is in a passenger door.

A fifth aspect of the invention provides an aircraft comprising a fuselage according to the fourth aspect; a port wing attached to the fuselage at a port wing root; and a starboard wing attached to the fuselage at a starboard wing root, wherein the window is on the port side of the fuselage and aft of the port wing root, or the window is on the starboard side of the fuselage and aft of the starboard wing root.

Optionally the window is on the port side of the fuselage and aft of the port wing root.

A sixth aspect of the invention provides an aircraft comprising a fuselage; a port wing attached to the fuselage at a port wing root; and a starboard wing attached to the fuselage at a starboard wing root, wherein the fuselage comprises: a passenger door on a port side of the fuselage and forward of the port wing root; a window on the port side of the fuselage and aft of the port wing root; a transmitter configured to generate outgoing light and transmit the outgoing light through the window, the outgoing light carrying aircraft-to-ground data; and a receiver configured to receive incoming light through the window and sense the incoming light, the incoming light carrying ground-to-aircraft data.

Optionally the transmitter is configured to modulate the outgoing light to encode the aircraft-to-ground data in the outgoing light.

Optionally the outgoing light and the incoming light are infrared light.

Optionally the outgoing light and the incoming light are infrared light with a wavelength greater than 1000 nm.

Optionally the outgoing light and the incoming light have different peak wavelengths.

Optionally the outgoing light and the incoming light are generated by lasers.

A seventh aspect of the invention provides an aircraft comprising an aircraft transceiver configured to transfer data to and from the aircraft by free-space-optical communication when the aircraft is parked, the aircraft transceiver comprising; a transmitter configured to generate outgoing light, the outgoing light carrying aircraft-to-ground data; a lens configured to collimate the outgoing light to generate a collimated beam; a beam steering device configured to transform the collimated beam to generate a steered beam; a control system configured to operate the beam steering device to adjust an angle of the steered beam; and a receiver configured to sense incoming light, the incoming light carrying ground-to-aircraft data, wherein the receiver is configured to receive the incoming light via the beam steering device and the lens.

Optionally the transmitter is configured to modulate the outgoing light to encode the aircraft-to-ground data in the outgoing light.

Optionally the outgoing light and the incoming light are infrared light.

Optionally the outgoing light and the incoming light are infrared light with a wavelength greater than 1000 nm.

Optionally the outgoing light and the incoming light have different peak wavelengths.

Optionally the outgoing light and the incoming light are generated by lasers.

Optionally the control system is configured to operate the beam steering device to adjust an angle of the incoming light so that the incoming light is received by the receiver.

Optionally the receiver comprises a quadrant photodetector configured to receive a first part of the incoming light via the beam steering device and the lens, and a sensor configured to receive a second part of the incoming light via the beam steering device and the lens, wherein the control system is configured to operate the beam steering device to adjust an angle of the incoming light so that the incoming light is centered on the quadrant photodetector.

Optionally the beam steering device is configured to transform the collimated beam by reflection, refraction or diffraction, to generate the steered beam.

Optionally the beam steering device comprises a diffractive optical element configured to diffract the collimated beam to generate the steered beam.

Optionally the aircraft transceiver is configured to transmit and/or receive data at a bit rate higher than 0.5 terabits per second.

Optionally the steered beam has a beam divergence less than 10 mrad or less than 5 mrad.

Optionally the steered beam has a beam divergence less than 10 mrad FWHM or less than 5 mrad FWHM.

Optionally the steered beam has a beam divergence greater than 0.5 mrad or greater than 1 mrad.

Optionally the steered beam has a beam divergence greater than 0.5 mrad FWHM or greater than 1 mrad FWHM.

Optionally the transmitter comprises a laser configured to generate the outgoing light.

Optionally the aircraft further comprises a fuselage; wings attached to the fuselage; and a window in the fuselage, wherein the aircraft transceiver is housed inside the fuselage, the transmitter is configured to transmit the outgoing light through the window, and the receiver is configured to receive the incoming light through the window.

Optionally the control system is configured to operate the beam steering device to steer the incoming light onto the receiver.

Optionally the aircraft transceiver further comprises a beacon.

An eighth aspect of the invention provides a vehicle comprising a vehicle transceiver configured to transfer data to and from a parked aircraft by free-space-optical communication, the vehicle transceiver comprising: a transmitter configured to generate outgoing light, the outgoing light carrying ground-to-aircraft data; a lens configured to collimate the outgoing light to generate a collimated beam; a beam steering device configured to transform the collimated beam to generate a steered beam; a control system configured to operate the beam steering device to adjust an angle of the steered beam; and a receiver configured to sense incoming light, the incoming light carrying aircraft-to-ground data, wherein the receiver is configured to receive the incoming light via the beam steering device and the lens.

Optionally the transmitter is configured to modulate the outgoing light to encode the ground-to-aircraft data in the outgoing light.

Optionally the outgoing light and the incoming light are infrared light.

Optionally the outgoing light and the incoming light are infrared light with a wavelength greater than 1000 nm.

Optionally the outgoing light and the incoming light have different peak wavelengths.

Optionally the outgoing light and the incoming light are generated by lasers.

Optionally the vehicle further comprises memory for storing the ground-to-aircraft data and the aircraft-to-ground data.

Optionally the memory has a capacity of more than 30 terabytes or more than 50 terabytes.

Optionally the vehicle is a ground-based vehicle or an airborne vehicle.

Any aspect of the invention may be combined with one or more other aspects of the invention, or combined with one or more optional features of other aspects of the invention.

### BRIEF DESCRIPTION OF THE DRAWINGS

Embodiments of the invention will now be described with reference to the accompanying drawings, in which:

FIG. 1 is a plan view showing an aircraft and vehicle;

FIG. 2 is a side view showing a steered beam being transmitted through a passenger window;

FIG. 3 is a cross-sectional view showing the steered beam of FIG. 3;

FIG. 4 is an enlarged cross-sectional view showing the aircraft transceiver and passenger window;

FIG. 5 is a side view showing a steered beam being transmitted through a window in a passenger door;

FIG. 6 is a cross-sectional view showing the steered beam of FIG. 5;

FIG. 7 is a side view showing a steered beam being transmitted through a dedicated fuselage window;

FIG. 8 is a cross-sectional view showing the steered beam of FIG. 7;

FIG. 9 is a schematic diagram of an aircraft transceiver;

FIG. 10 is a schematic diagram of a vehicle transceiver;

FIG. 11 shows a first method of transferring data from the vehicle;

FIG. 12 shows a continuous method of transferring data from the vehicle;

FIG. 13 shows a first stage of an acquisition process;

FIG. 14 shows a second stage of the acquisition process; and

FIG. 15 shows a third stage of the acquisition process.

### DETAILED DESCRIPTION OF THE PREFERRED EMBODIMENTS

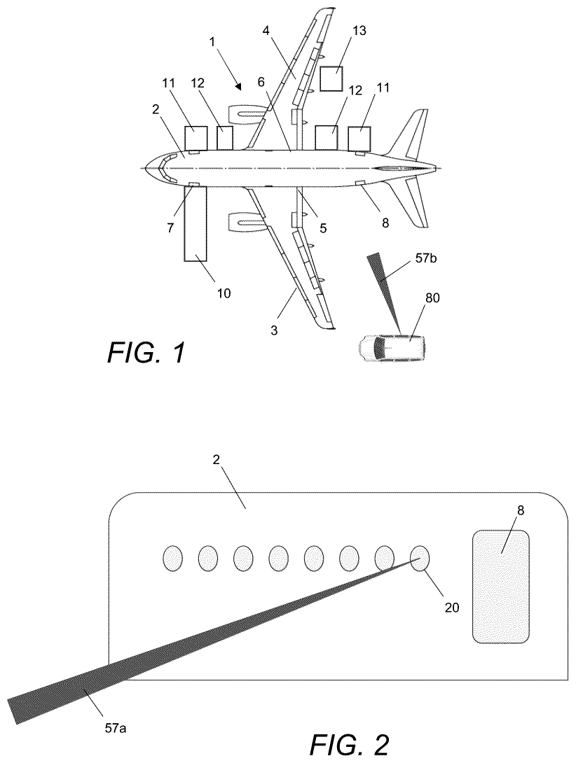

An aircraft 1 shown in FIG. 1 comprises a fuselage 2, and port and starboard wings 3, 4. The port wing 3 is attached to the fuselage 2 at a port wing root 5 and the starboard wing 4 is attached to the fuselage 2 at a starboard wing root 6. The fuselage 2 comprises a forward passenger door 7 on a port side of the fuselage 2 forward of the port wing root, and an aft passenger door 8 on a port side of the fuselage 2 aft of the port wing root 5.

The aircraft 1 is parked at a gate with a passenger bridge 10 docked at the forward passenger door 7, and various service vehicles 11-13 on the starboard side of the aircraft. The service vehicles include catering vehicles 11, luggage loading vehicles 12 and a refuelling vehicle 13.

The fuselage 2 has passenger windows on the port and starboard sides of the fuselage 2. FIG. 2 shows the port passenger windows aft of the port wing root 5. Similar passenger windows (not shown) are provided on the starboard side of the fuselage 2. The aft-most port passenger window 20 is next to an aft passenger door 8.

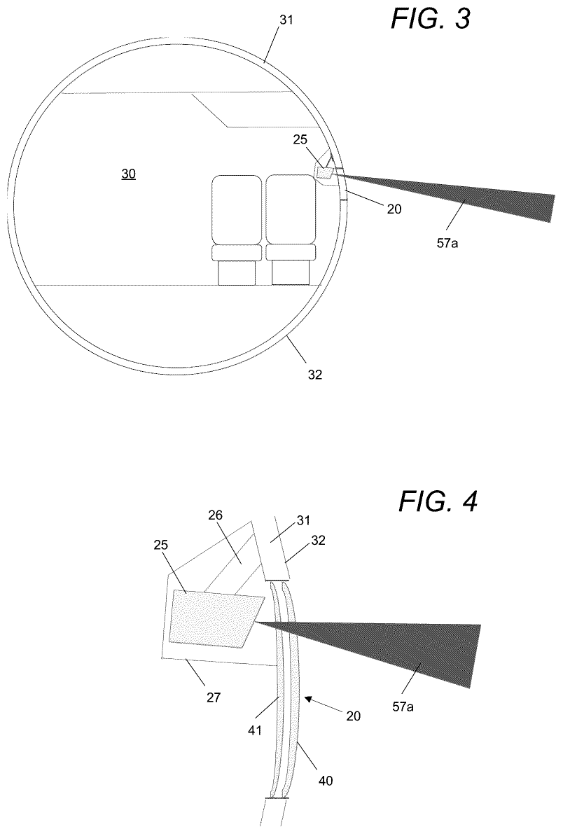

An aircraft transceiver 25 shown in FIGS. 3 and 4 is housed inside the fuselage 2, in a pressurized and temperature-controlled passenger compartment 30, next to the aft-most port passenger window 20 and adjacent to a passenger seat. The fuselage 2 comprises a fuselage shell 31 with an outer skin 32. The window is fit into a cut-out in the fuselage shell 31. As shown in FIG. 4, the window is double-layered with a transparent outer pane 40 and a transparent inner pane 41. The aircraft transceiver 25 is mounted to the fuselage shell 31 by a strut 26 and covered by a housing 27.

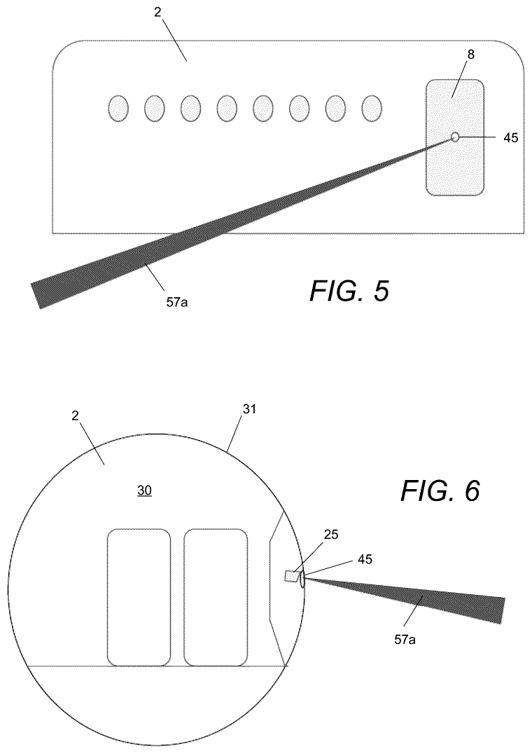

An alternative location for the aircraft transceiver 25 is shown in FIGS. 5 and 6. In this case the aircraft transceiver 25 is positioned next to a window 45 in the aft passenger door 8.

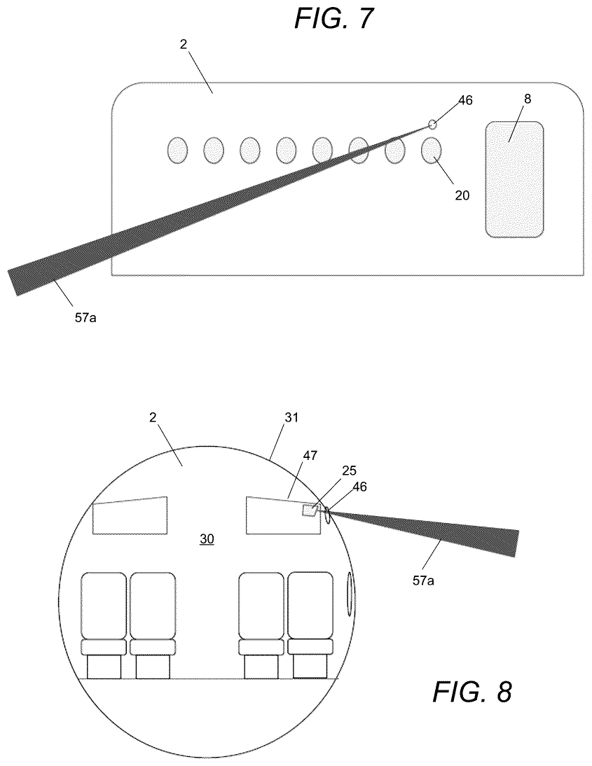

An alternative location for the aircraft transceiver 25 is shown in FIGS. 7 and 8. In this case the aircraft transceiver 25 is positioned next to a dedicated window 46 in the fuselage shell 31. The aircraft transceiver 25 is inside an overhead luggage compartment 47, above the aft-most port passenger window 20.

By way of example the aircraft transceiver 25 may have a weight of less than 1 kg, and dimensions of 10×10×7 cm. This makes the transceiver sufficiently small and light to be accommodated in the passenger compartment.

In all cases the window 20, 45, 46 is aft of the passenger door. This location is preferred compared to using the cockpit window, because the cockpit is typically too congested to be able to accommodate the aircraft transceiver 25.

In all cases the window 20, 45, 46 is on a port or starboard side of the fuselage. This is preferred, compared to using a window at the top of the fuselage, because it ensures the window 20, 45, 46 is in a line of sight of a ground-based vehicle.

The embodiments of FIGS. 3-6 can be easily retro-fitted into an existing aircraft, whereas the embodiment of FIGS. 7 and 8 is more suited to a new aircraft.

Housing the aircraft transceiver 25 inside the fuselage 2 and behind a window solves the problem of keeping it at a relatively high temperature and protecting it from vibration during flight. This enables delicate optical components to be used in the transceiver without the need for separate heating and vibration damping systems for the transceiver, which would require higher space allocation, cost and complexity.

The aircraft transceiver 25 is configured to transfer data to and from the aircraft by free-space-optical communication with a vehicle 80, such as a wheeled automobile, when the aircraft 1 is parked as in FIG. 1.

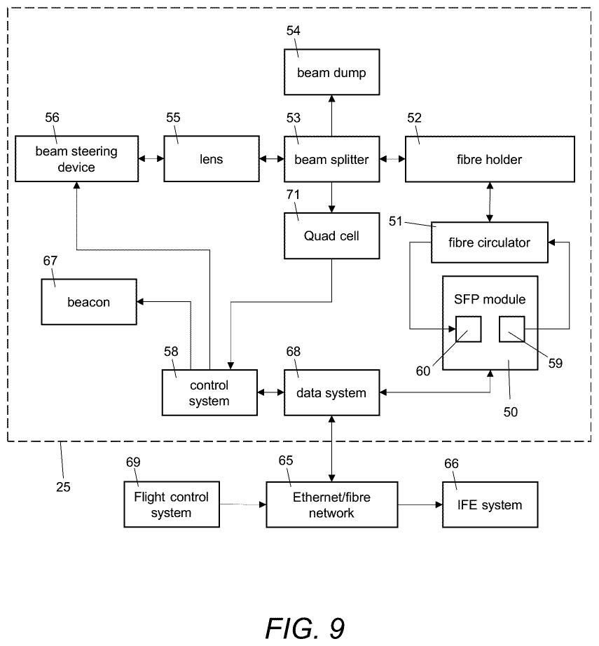

FIG. 9 shows details of the aircraft transceiver 25. The aircraft transceiver 25 comprises a small form-factor pluggable (SFP) module 50 comprising a solid state laser 59 configured to generate outgoing light, and a sensor 60 configured to sense incoming light.

The SFP module 50 may be a commercial off-the-shelf item such as: the 400G CFP2-DCO module from II-VI Incorporated (Nasdaq:IIVI), described at https:/ii-vi.com/news/ii-vi-incorporated-introduces-400g-cfp2-dco-pluggable-transceivers-for-high-speed-backbone-networks-and-datacenter-interconnects/(online 10 Jan. 2024); or the module described at https://www.fibremall.com/blog/400g-dwdm-cfp2-dco-module.htm (online 10 Jan. 2024); or one of the modules described at https://www.fibremall.com/blog/coherent-transceiver-overview.htm (online 10 Jan. 2024).

The outgoing light is directed into an optical fiber by a fiber circulator 51. The optical fiber is held by a fiber holder 52 with XYZ micrometric adjustment. The outgoing light from the end of the optical fiber is split by a 90:10 beam splitter 53, 10% of the light being diverted into a beam dump 54. The rest of the outgoing light is directed into a lens 55 which is configured to collimate the outgoing light to generate a collimated beam.

A beam steering device 56 is configured to transform the collimated beam to generate a steered beam 57a shown in FIGS. 2-8 which is output by the aircraft transceiver 25 through the window 20, 45 or 46. A control system 58 is configured to operate the beam steering device 56 to adjust an angle of the steered beam 57a.

The beam steering device 56 may be a tip/tilt mirror configured to reflect the collimated beam to generate the steered beam 57a; a refractive element (such as a pair of prisms or a Liquid Crystal Polarization Grating (LCPG)) configured to refract the collimated beam to generate the steered beam 57a; or a diffractive element (such as a 3D switchable diffractive optical element (DOE)) configured to diffract the collimated beam to generate the steered beam 57a.

In a preferred embodiment the beam steering device 56 is an LCPG or a DOE, because they are small and light and offer fast response rates required to cope with atmospheric turbulence (as would be generated by the airport tarmac heated by the sun).

The aircraft transceiver 25 has various delicate optical components (such as the lens 55 and beam steering device 56) which may be damaged by low temperature or vibration during flight. Housing the aircraft transceiver 25 in the fuselage 2 provides protection against such low temperatures and vibration.

The transmitter and receiver share the beam steering device 56 and lens 55, rather than each having a dedicated beam steering device or lens. This makes the aircraft transceiver 25 sufficiently small and light to be accommodated inside the fuselage.

The control system 58 may be configured to operate the beam steering device 56 to adjust an angle of the steered beam 57a through a range of angles of +1-5 degrees, giving a field of regard (FOR) of 10 degrees. This is equal to an 8 m box at a range of 45 m.

The aircraft transceiver 25 also has a data system 68 which receives aircraft-to-ground data from an ethernet/fiber network 65 of the aircraft 1. By way of example, the aircraft-to-ground data may comprise data recording the performance of the aircraft engines during flight of the aircraft, received from a flight control system 69.

The SFP module 50, or another part of the transceiver, may comprise a modulator (not shown) which receives the aircraft-to-ground data from the data system 68 and modulates the outgoing light to encode the aircraft-to-ground data in the outgoing light.

The sensor 60 is configured to receive incoming light from a collimated beam 57b (shown in FIG. 1) from the vehicle 80 through the window 20, 45 or 46 and sense the incoming light, the incoming light carrying ground-to-aircraft data. More particularly: the incoming light is received by the beam steering device 56 which performs the reverse of the transformation applied to the outgoing light, to steer the incoming light onto the receiver. That is, the beam steering device 56 transforms the collimated beam 57b to generate a steered beam which is focused by the lens 55 onto a quadrant photodetector 71 and onto the end of the optical fiber. The incoming light is split by the beam splitter 53 so 10% falls on the quadrant photodetector 71 and the rest falls on the optical fiber.

The sensor 60 then receives the incoming light from the optical fiber via the fiber circulator 51.

The SFP module 50 comprises a demodulator (not shown) which demodulates the incoming light to obtain the ground-to-aircraft data, which it then sends to the data system 68. The data system 68 then forwards the ground-to-aircraft data to the ethernet/fiber network 65 of the aircraft. The ground-to-aircraft data is stored at the aircraft. By way of example, the ground-to-aircraft data may comprise infotainment data which is stored by an in-flight entertainment (IFE) system 66 of the aircraft.

The aircraft transceiver 25 also has a beacon 67 in the form of a light emitting diode (LED) array. The LED array comprises an array (for example a 3×3 array) of light sources in bi-static configuration. By way of example, each light source may comprise an infrared LED L12509-0155L with an integrated lens, supplied by Hamamatsu Photonics KK, of Hamamatsu City, Japan, as described online at https//www.hamamatsu.com/jp/en/product/light-and-radiation-sources/led/L12509-0155L.html (online 10 Jan. 2024). The LEDs all point in the same direction.

By way of example, each light source of the beacon 67 may emit infrared light at a peak wavelength of about 1550 nm.

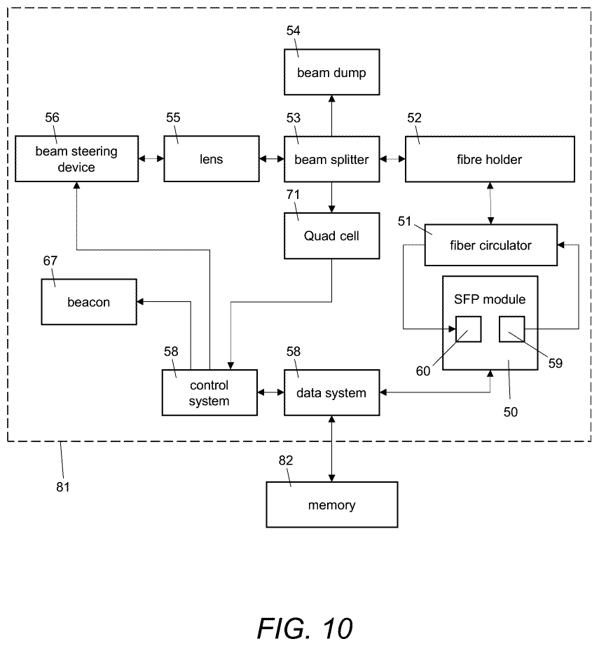

The vehicle 80 has a vehicle transceiver 81, shown in FIGS. 10, which is substantially identical to the aircraft transceiver 25. The elements of the vehicle transceiver 81 which have equivalents in the aircraft transceiver 25 are given the same reference number in FIG. 10 and will not be described again.

The laser 59 of the vehicle transceiver 81 is configured to generate outgoing light which is output as a steered and collimated beam 57b shown in FIG. 1, the outgoing light carrying ground-to-aircraft data; and the sensor 60 of the vehicle transceiver 81 is configured to receive incoming light (the steered and collimated beam 57a from the aircraft) and sense the incoming light, the incoming light carrying the aircraft-to-ground data as previously described.

Each steered beam 57a,b typically contains infrared light at a wavelength above 1000 nm. For instance each steered beam 57a,b may contain infrared light in the range of 1528-1570 nm, with a bandwidth of less than 0.1 nm (FWHM) and an intensity of up to 10 mW. Such infrared light is “eye safe” and hence safe to transmit into the aircraft and into the vehicle.

Optionally the steered beams 57a,b have different peak wavelengths, to avoid interference. For example the steered beam 57a from the aircraft may have a peak wavelength of 1530 nm and the steered beam 57b from the vehicle may have a peak wavelength of 1570 nm.

The vehicle 80 also has memory 82 for storing the aircraft-to-ground data and the ground-to-aircraft data. The memory 82 may comprise multiple memory units (such as a first hard drive for the aircraft-to-ground data and a second hard drive for the ground-to-aircraft data) or a single memory unit (such as a single hard drive) which stores all the data.

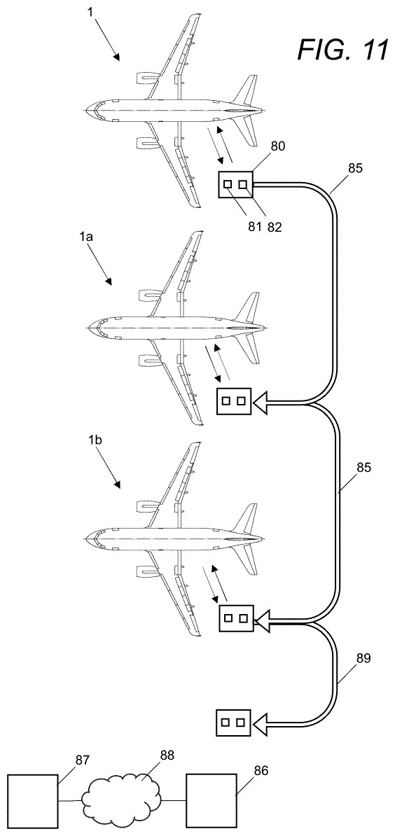

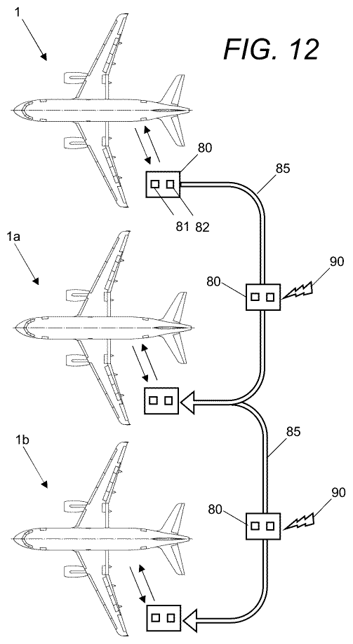

The vehicle 80 is a dedicated vehicle which is used to exchange data with a plurality of parked aircraft 1, la, lb as shown in FIG. 11 or 12. Each aircraft 1a, lb has an aircraft transceiver similar to the aircraft transceiver 25 of the aircraft 1.

The vehicle 80 is driven between the aircraft, and at each aircraft the vehicle transceiver 81 is operated to receive aircraft-to-ground data from the aircraft by free-space-optical communication and transmit ground-to-aircraft data from the vehicle to the aircraft by free-space-optical communication.

The vehicle 80 may be driven by a human, or it may be autonomous (driverless).

Communicating via a window 20, 45 or 46 aft of the forward passenger door 7 enables the vehicle 80 to have a clear line of sight to the window, not obscured by the passenger bridge 10.

The port side of the fuselage is a particularly preferred location for the window because it avoids congestion with service vehicles on the starboard side of the aircraft.

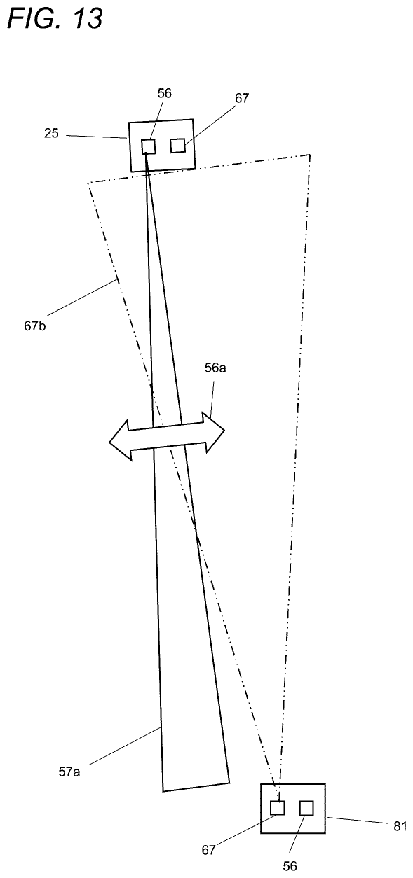

At each aircraft, an acquisition process shown in FIGS. 13-15 is used to align the steered beams 57a, 57b of the two transceivers.

First, the vehicle transceiver 81 turns on its beacon 67 to generate a vehicle beacon beam 67b shown in FIG. 13. The vehicle beacon beam 67b may have a divergence of about +15 degrees FWHM.

The aircraft transceiver 25 also turns on its laser 59 to generate a steered beam 57a shown in FIG. 13. By way of example, the steered beam 57a may have a beam diameter of about 2 cm at 45 m (i.e. a beam divergence of about 0.5 mrad FWHM) or a beam diameter of about 10 cm at 45 m (i.e. a beam divergence of about 2 mrad FWHM). The divergence of the steered beams 57a, 57b is exaggerated in FIGS. 13-15 for ease of illustration.

Next, the beam steering device 56 of the aircraft transceiver 25 performs a coarse raster scan 56a, jumping from point to point over a 3×3 array (nine points) with about 10 ms per point.

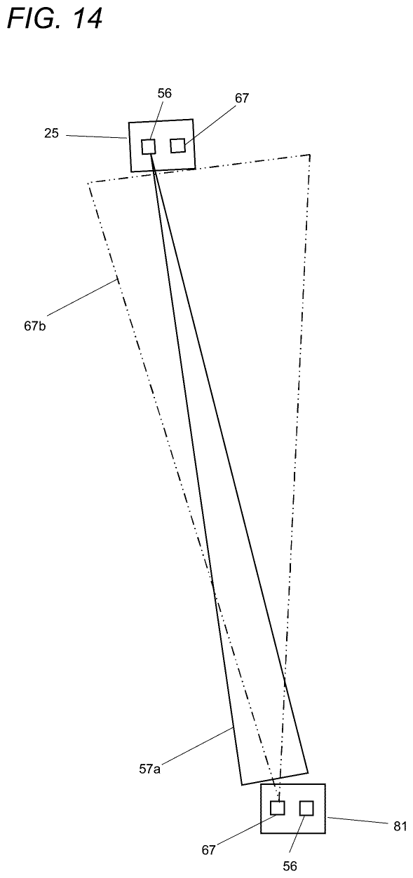

At one of these nine points of the raster scan, rays from the vehicle beacon beam 67b will fall on some part of the quadrant photodetector 71 of the aircraft transceiver 25. At this point, the coarse raster scan is stopped and the beam steering device 56 of the aircraft transceiver 25 performs a fine adjustment until all four quadrants of the quadrant photodetector 71 of the aircraft transceiver 25 are reading the same value. Light from the beacon beam 67b now illuminates all four quadrants of the quadrant photodetector 71 of the aircraft transceiver 25. Also, the fine adjustment will cause the steered beam 57a from the aircraft transceiver 25 to be centered on the beacon 67 of the vehicle transceiver 81 as shown in FIG. 14.

Since the steered beam 57a has a certain degree of divergence, some of the light from the steered beam 57a will also enter the aperture of the beam steering device 56 of the vehicle transceiver 81.

Next, the beam steering device 56 of the vehicle transceiver 81 performs a coarse raster scan, jumping from point to point over a 3×3 array (nine points) with about 10 ms per point.

At one of these nine points of the raster scan, the steered beam 57a from the aircraft transceiver 25 will fall on the quadrant photodetector 71 of the vehicle transceiver 81. At this point, the coarse raster scan is stopped and the beam steering device 56 of the vehicle transceiver 81 performs a fine adjustment until all four quadrants of the quadrant photodetector 71 of the vehicle transceiver 81 are reading the same value. At this stage the steered beam 57a from the aircraft transceiver 25 is centered on the quadrant photodetector 71 of the vehicle transceiver 81.

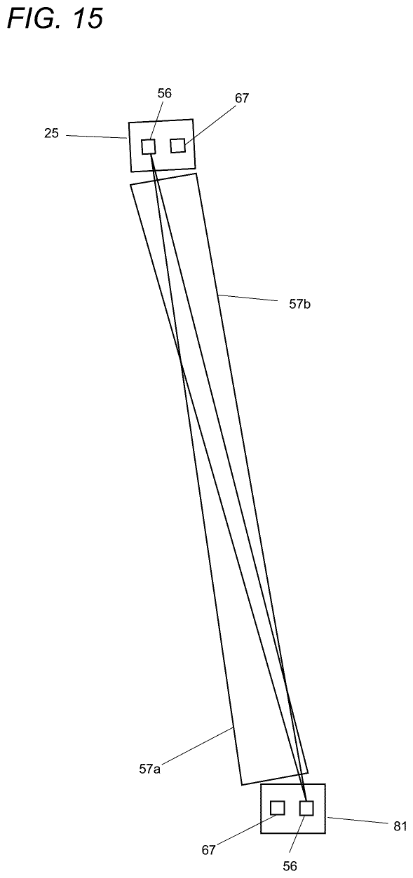

Finally, the vehicle transceiver 81 turns off its beacon 67 and turns on its laser to generate a steered beam 57b shown in FIG. 15. Since the steered beam 57a from the aircraft transceiver 25 has previously been steered onto the quadrant photodetector 71 of the vehicle transceiver 81, the steered beam 57b from the vehicle transceiver 81 also falls on the quadrant photodetector 71 of the aircraft transceiver 25.

At the end of the acquisition process, the angles of the steered beams 57a, 57b have been adjusted so that the steered beams 57a, 57b are substantially aligned with each other as in FIG. 15.

The acquisition process shown in FIGS. 13-15 can be done quickly, for example in 180 ms (less than a second).

Once the steered beams 57a,b have been steered onto the quadrant photodetectors 71, a continuous feedback loop is operated by each transceiver 25, 81 to keep them steered onto the quadrant photodetectors 71 during data transmission.

In the example above the vehicle transceiver 81 turns on its laser to generate the steered beam 57b at the end of the acquisition process. In an alternative acquisition process, both lasers may be turned on at the start and the beam steering devices 56 scanned concurrently until each transceiver senses light on its quadrant photodetector 71.

To sum up, the control system 58 of each transceiver 25, 81 is configured to operate its beam steering device 56 to adjust an angle of the steered beam output by the transceiver, and also to adjust an angle of incoming light from the other transceiver so that a first part of the incoming light falls on the quadrant photodetector 71, and a second part of the incoming light falls on the end of the optical fiber and is routed to the sensor 60.

FIG. 11 shows the path 85 driven by the vehicle 80 between the aircraft. The vehicle 80 is driven directly between the aircraft, one-by-one. The position of the vehicle at each aircraft is also shown.

By communicating via a window on a port side of the fuselage 2, the vehicle 80 can move quickly between the parked aircraft without getting in the way of service vehicles on the starboard side of the aircraft.

Communicating via a window 20, 45 or 46 aft of the wing root 5 enables the vehicle 80 to follow a relatively short and uncongested path 85 behind the aircraft.

The stored aircraft-to-ground data accumulates in the memory 82 of the vehicle 80 before the data is transferred from the vehicle 80. The aircraft-to-ground data can then be transferred from the vehicle 80 in a number of different ways.

In a first example shown in FIG. 11, the vehicle 80 accumulates a full set of aircraft-to-ground data from all of the parked aircraft 1, 1a, 1b, then the vehicle 80 drives to a base 86 via a path 89. The full set of aircraft-to-ground data is then transferred from the vehicle at the base 86.

The full set of aircraft-to-ground data may be transferred from the vehicle at the base 86 by free-space-optical communication using the vehicle transceiver 81, or by a wired connection via a fiber access point. The aircraft-to-ground data may then be uploaded from the base 86 to an airline 87 via the cloud 88.

Alternatively some, or all, of the accumulated aircraft-to-ground data may be stored on the vehicle in a memory unit of the memory 82, such as a 100 TB hard drive, and this aircraft-to-ground data is transferred from the vehicle 80 by physically removing the memory unit from the vehicle 80 (when the vehicle is at the base 86, or elsewhere) and taking the memory unit to the airline 87. Optionally the memory 82 may comprise multiple memory units, one per airline.

In another example shown in FIG. 12, the aircraft-to-ground data accumulates in the memory 82 and is transferred from the vehicle 80 by continuous (and slow) upload using 4G/5G/6G wireless communications 90. This communication 90 can occur at the same time as the vehicle 80 is exchanging data with the aircraft, and/or at the same time as the vehicle 80 is driving between aircraft along the path 85.

The transceivers 25, 81 are designed to operate at a range less than 100 m (for example 30-45 m) and at a rate higher than 0.5 terabits per second (Tbps), for example 1 Tbps, in each direction. The low divergence of the steered beams 57a, 57b is one of the factors that makes such high data rates possible.

Each aircraft 1, 1a, 1b typically sends about 7 terabytes of aircraft-to-ground data to the vehicle 80, which takes about 1 minute per aircraft. The vehicle 80 typically sends about 30 TB of ground-to-aircraft data to each aircraft, which takes about 4 minutes per aircraft. This high rate of data exchange enables the method shown in FIGS. 11 and 12 to be employed while the aircraft are parked, without affecting their turnaround time.

In the example of FIGS. 11 and 12 only three aircraft are shown, but a larger number of aircraft may be serviced by the vehicle 80, depending on the capacity of the memory 82 of the vehicle, the data rate of the 4G/5G/6G wireless communications, and the turnaround time of the aircraft.

Taking the example of FIG. 11 with three aircraft, stored aircraft-to-ground data from all three aircraft 1, 1a, 1b accumulates in the memory 82 at the vehicle 80 before the data is transferred from the vehicle at the base 86. Hence the memory 82 of the vehicle must have capacity for 30 TB of ground-aircraft data, and 21 TB for the full set of aircraft-to-ground data. So in this case a 60 TB hard drive will be sufficient. If the memory 82 of the vehicle has a higher capacity, for example 100 TB or 200 TB, then it will be able to service a larger number of aircraft before returning to the base 86.

Taking the example of FIG. 12, the amount of stored aircraft-to-ground data accumulating at the memory 82 of the vehicle will depend on the data rate of the 4G/5G/6G wireless communications 90, the number of aircraft, the time spent at each aircraft and the time spent to drive between the aircraft. Assuming that the data rate of the 4G/5G/6G wireless communications 90 is relatively slow, then stored aircraft-to-ground data from two or more of the aircraft will typically accumulate in the memory 82 at the vehicle 80 before it is transferred from the vehicle. Typically, the data rate of the 4G/5G/6G wireless communications 90 is very slow, so it may take 30 minutes to exchange data with the three aircraft, and many hours to upload the aircraft-to-ground data for all three aircraft using the 4G/5G/6G wireless communications 90.

At each aircraft, ground-to-aircraft data is transmitted from the vehicle to the aircraft by free-space-optical communication and stored at the aircraft. Optionally the ground-to-aircraft data is the same for each aircraft 1, 1a, 1b. For example, all of the aircraft may be owned by the same airline and the ground-to-aircraft data may comprise a common batch of infotainment content for that airline. Alternatively, the ground-to-aircraft data may vary between the aircraft 1, la, lb.

Typically, at each aircraft more than 10 terabytes of ground-to-aircraft data or more than 20 terabytes of ground-to-aircraft data are transmitted to the aircraft by the free-space-optical communication.

High data rates are achieved, in part, by using steered beams 57a/b (typically laser beams) with low divergence (typically less than 10 mrad FWHM or less than 5 mrad FWHM). A divergence greater than 0.5 mrad FWHM or greater than 1 mrad FWHM may be preferred, to ensure that each steered beam 57a, 57b has a sufficiently large beam diameter to fall on both the beacon 67 and the aperture of the beam steering device 56 as shown in FIG. 14.

Data coding may be optimized for short range whilst providing robustness of communication in rainy or foggy conditions.

The vehicle 80 can drive past many aircraft and upload/download terabytes of data during the course of a day and then drive to the airline headquarters or a data center at the end of the day to upload the data to the cloud.

The assumption that the collimated beams 57a, 57b will only travel through tens of meters of atmosphere enables the transceiver design to be economical with low power, and enables a small aperture for the beam steering device 56, typically under two inches (5 cm) in diameter.

In the examples above, the vehicle 80 is a land-based wheeled vehicle which is driven between the aircraft, either by a human driver or by an autonomous driving system. In an alternative embodiment of the invention, the vehicle 80 may be replaced by an airborne autonomous vehicle (or “drone”), such as a quadcopter, which carries a vehicle transceiver and memory similar to the land-based vehicle 80. The airborne autonomous vehicle moves between the aircraft by flying, rather than by driving. In this case the window may be at the top of the fuselage, in a line of sight of the airborne autonomous vehicle. Such a window at the top of the fuselage may be positioned aft of the passenger door 7, or forward of the forward passenger door 7.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method comprising:
moving a vehicle between a plurality of parked aircraft;
at each parked aircraft of the plurality of parked aircraft, receiving aircraft-to-ground data from said parked aircraft at the vehicle by free-space-optical communication and storing the aircraft-to-ground data at the vehicle as stored aircraft-to-ground data; and
transferring the stored aircraft-to-ground data from the vehicle, wherein stored aircraft-to-ground data from two or more of the parked aircraft accumulates at the vehicle before the stored aircraft-to-ground data is transferred from the vehicle.

2. The method of claim 1, further comprising:
moving the vehicle to a base after it has accumulated a full set of aircraft-to-ground data comprising the stored aircraft-to-ground data from all of the parked aircraft of the plurality of parked aircraft; and
transferring the full set of aircraft-to-ground data from the vehicle at the base.

3. The method of claim 2, wherein the full set of aircraft-to-ground data is transferred from the vehicle at the base by free-space-optical communication.

4. The method of claim 1, wherein at least some of the aircraft-to-ground data is stored in a memory unit and transferred from the vehicle by physically removing the memory unit from the vehicle.

5. The method of claim 1, wherein the stored aircraft-to-ground data is transferred from the vehicle simultaneously with the vehicle moving between the parked aircraft.

6. The method of claim 1, wherein each parked aircraft of the plurality of parked aircraft comprises an aircraft fuselage comprising:
a window; and
an aircraft transceiver housed inside the fuselage, the aircraft transceiver comprising a transmitter; and wherein at each parked aircraft of the plurality of parked aircraft the transmitter generates an outgoing light and transmits the outgoing light through the window, the outgoing light carrying the aircraft-to-ground data.

7. The method of claim 6, wherein each parked aircraft of the plurality of parked aircraft further comprises a port wing attached to the fuselage at a port wing root; and a starboard wing attached to the fuselage at a starboard wing root, wherein the window is on a port side of the fuselage and aft of the port wing root, or the window is on a starboard side of the fuselage and aft of the starboard wing root.

8. The method of claim 1, further comprising:
at each parked aircraft of the plurality of parked aircraft, transmitting ground-to-aircraft data from the vehicle to the parked aircraft by free-space-optical communication and storing the ground-to-aircraft data at the parked aircraft.

9. The method of claim 8, wherein the aircraft-to-ground data is received at the vehicle via an incoming steered beam; the ground-to-aircraft data is transmitted from the vehicle via an outgoing steered beam; and the method further comprises:
at each parked aircraft of the plurality of parked aircraft, adjusting an angle of each steered beam so that the incoming steered beams and the outgoing steered beams are substantially aligned with each other.

10. A method comprising:
moving a vehicle between a plurality of parked aircraft;
at each parked aircraft of the plurality of parked aircraft, transmitting ground-to-aircraft data from the vehicle to the parked aircraft of the plurality of parked aircraft by free-space-optical communication; and
storing the ground-to-aircraft data at the parked aircraft.

11. The method of claim 10, wherein at each parked aircraft of the plurality of parked aircraft, more than 10 terabytes of ground-to-aircraft data are transmitted to the parked aircraft by the free-space-optical communication.

12. The method of claim 8, wherein each parked aircraft of the plurality of parked aircraft comprises an aircraft fuselage comprising: a window; and an aircraft transceiver housed inside the fuselage, the aircraft transceiver comprising a receiver; and wherein at each parked aircraft of the plurality of parked aircraft the receiver receives incoming light through the window and senses the incoming light, the incoming light carrying the ground-to-aircraft data.

13. The method of claim 12, wherein each parked aircraft of the plurality of parked aircraft comprises a port wing attached to the fuselage at a port wing root; and a starboard wing attached to the fuselage at a starboard wing root, wherein the window is on a port side of the fuselage and aft of the port wing root, or the window is on a starboard side of the fuselage and aft of the starboard wing root.

14. The method of claim 1, wherein the aircraft-to-ground data is received at the vehicle via an incoming beam with a divergence less than 10 mrad, or
wherein the ground-to-aircraft data is transmitted from the vehicle via an outgoing beam with a divergence less than 10 mrad, or
both.

15. A vehicle for communicating with a parked aircraft by free-space-optical communication, the vehicle comprising:
a transmitter configured to generate an outgoing light, the outgoing light carrying ground-to-aircraft data;
a receiver configured to receive an incoming light and sense the incoming light, the incoming light carrying aircraft-to-ground data; and
memory for storing the ground-to-aircraft data and the aircraft-to-ground data.

16. The vehicle of claim 15, further comprising:
a lens configured to collimate the outgoing light to generate a collimated beam.

17. The vehicle of claim 16, wherein the receiver is configured to receive the incoming light via the lens.

18. The vehicle of claim 15, further comprising:
a beam steering device configured to transform the outgoing light to generate a steered beam; and
a control system configured to operate the beam steering device to adjust an angle of the steered beam.

19. The vehicle of claim 18, wherein the receiver is configured to receive the incoming light via the beam steering device.

20. The vehicle of claim 15, further comprising:
a lens configured to collimate the outgoing light to generate a collimated beam;
a beam steering device configured to transform the collimated beam to generate a steered beam; and
a control system configured to operate the beam steering device to adjust an angle of the steered beam, wherein the receiver is configured to receive the incoming light via the beam steering device and the lens.
